(19) United States
(12) Patent Application Publication
(10) Pub. No.: US 2024/0383410 A1
(43) Pub. Date: Nov. 21, 2024

(54) Vehicle Trunk Tack Organizer System

(71) Applicant: Anne-Sophie Mimieux Sherman, North Potomac, MD (US)

(72) Inventor: Anne-Sophie Mimieux Sherman, North Potomac, MD (US)

(21) Appl. No.: 18/318,160

(22) Filed: May 16, 2023

(51) Int. Cl. B60R 7/08

(52) U.S. Cl. CPC B60R 7/08

(57) ABSTRACT

The present invention relates to a vehicle trunk tack organizer system for organizing horse-related supplies and equipment within a vehicle. The system is primarily comprised of at least one base with at least one recessed area, at least one saddle rack holder, and at least one cover. The base can be placed within a trunk, truck bed, or interior of a vehicle and may have a plurality of recessed or divided areas that may be shaped to receive at least one storage box and other horse-related equipment and supplies. The base may also be comprised of a boot holder and a saddle rack holder.

### FIELD OF THE INVENTION

The present invention relates generally to the field of organization devices. More specifically, the present invention relates to a vehicle trunk tack organizer system for organizing horse-related supplies and equipment within a vehicle. The system is primarily comprised of at least one base with at least one recessed area, at least one saddle rack holder, and at least one cover. The base can be placed within a trunk, truck bed, or interior of a vehicle and may have a plurality of recessed or divided areas that may be shaped to receive at least one storage box and other horse-related equipment and supplies. The base may also be comprised of a boot holder and a saddle rack holder. The system is also comprised of a cover that can be placed around the base to make the system visually appealing while in use. Accordingly, the present disclosure makes specific reference thereto. Nonetheless, it is to be appreciated that aspects of the present invention are also equally applicable to other like applications, devices, and methods of manufacture.

### BACKGROUND

Many individuals compete in equestrian riding. Other individuals may ride horses as a hobby. Riding horses requires that a user transport various equipment such as boots, saddles, and other riding tack and supplies that are necessary to ride and maintain a horse.

These items are often transported in the trunk of a vehicle. However, said items are often covered in mud, dirt, dust, hay, feed, etc., that dirties the interior of the vehicle. In addition, the various items often become entangled within a vehicle trunk or are thrown together such that they give off a messy and unkempt appearance.

Therefore, there exists a long-felt need in the art for a system that allows a user to easily transport a plurality of horse-related supplies and equipment. There also exists a long-felt need in the art for a vehicle trunk tack organizer system that allows a user to easily transport a plurality of horse-related supplies and equipment in a trunk of a vehicle, wherein the system prevents the vehicle interior from becoming dirty. Further, there exists a long-felt need in the art for a vehicle trunk tack organizer system that allows a user to easily transport a plurality of horse-related supplies and equipment in a trunk of a vehicle, wherein the system prevents the vehicle interior from becoming dirtied and keeps the supplies and equipment in an organized manner.

The subject matter disclosed and claimed herein, in one embodiment thereof, comprises a vehicle trunk tack organizer system. The system is primarily comprised of at least one base with at least one recessed area, at least one saddle rack holder, and at least one cover. The base can be placed within a trunk, truck bed, or interior of a vehicle. The base may have a plurality of recessed or divided areas that may be shaped to receive horse-related equipment and supplies. The base and areas further collect dirt and debris from said equipment and supplies. The base may also be comprised of a boot holder and a saddle rack holder. In addition, the base may receive at least one storage box. The system is also comprised of a cover that can be placed around the base to make the system visually appealing while in use.

In this manner, the vehicle trunk tack organizer system of the present invention accomplishes all of the foregoing objectives and provides a system that allows a user to easily transport a plurality of horse-related supplies and equipment. More specifically, the system allows a user to easily transport a plurality of horse-related supplies and equipment in the trunk of a vehicle while preventing the vehicle interior from becoming dirty. In addition, the system keeps the supplies and equipment organized while within a vehicle.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle trunk tack organizer system. The system is primarily comprised of at least one base with at least one recessed area, at least one saddle rack holder, and at least one cover. The base is preferably comprised of at least one side wall that is preferably taller than the base such that any liquid or debris on the top surface cannot fall off the base and dirty the surrounding area of a vehicle interior. The bottom surface of the base may also be comprised of a non-slip material that prevents the bottom surface from slipping within the trunk, truck bed, or interior of a vehicle.

The base may have at least one recessed area. The recessed area may be specifically shaped to receive any horse equipment, food, medicine, item, object, etc., known in the art. The recessed area secures an item in place on the base such that it does not move during transport within a vehicle. In a differing embodiment, the base may be comprised of at least one raised interior wall that forms the area.

The system is also comprised of at least one storage box. The box is preferably comprised of at least one handle. The box may also be comprised of at least one lid that can be locked via at least one lock of any type known in the art. The box allows a user to store horse equipment, food, medicine, items, objects, etc. The box is preferably sized such that it can fit within the recessed area. In this manner, the box cannot topple over or move on the base during transport.

At least one area (or portion of the base) may be comprised of at least one boot holder that can receive at least one boot in an upside-down manner. The holder prevents the boot from moving during transport and also prevents the bottom of a dirty boot from contacting the base. When not in use, the boot holder may be folded to the base via at least one pivot point.

Another recessed area (or portion of the base) may be comprised of at least one saddle rack holder. The holder receives at least one saddle. The holder is comprised of a cross member that receives an underside of a saddle. The saddle rack holder preferably folds toward the base when not in use.

The system is also comprised of at least one cover that can be placed over the entire base during use such that the system is visually appealing. The body of the cover may be comprised of at least one fastener that attaches to at least one reciprocating fastener on the base to secure the cover to the base. The body is preferably made from a fabric material that may have at least one indicia such as, but not limited to, patterns, logos, emblems, images, symbols, designs, letters, numbers, words, characters, animals, advertisements, brands, etc., to make the cover visually appealing. The body is supported by at least one frame that may be made from a lightweight plastic material.

Accordingly, the vehicle trunk tack organizer system of the present invention is particularly advantageous as it provides a system that allows a user to easily transport a plurality of horse-related supplies and equipment in a trunk of a vehicle while preventing the vehicle interior from becoming dirty. Further, the system keeps the supplies and equipment organized within a vehicle. In this manner, the vehicle trunk tack organizer system overcomes the limitations of existing methods of transporting horse-related supplies within a vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle trunk tack organizer system of the present invention while inside a vehicle interior in accordance with the disclosed architecture;

FIG. 2 illustrates a perspective view of one potential embodiment of a vehicle trunk tack organizer system of the present invention while being used to store boots and a saddle in accordance with the disclosed architecture;

FIG. 3 illustrates a perspective view of one potential embodiment of a vehicle trunk tack organizer system of the present invention wherein the boot holder and saddle rack are erected in accordance with the disclosed architecture;

FIG. 4 illustrates a perspective view of one potential embodiment of a vehicle trunk tack organizer system of the present invention wherein the boot holder and saddle rack are folded in accordance with the disclosed architecture; and

FIG. 5 illustrates a perspective view of a cover and a base of one potential embodiment of a vehicle trunk tack organizer system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that allows a user to easily transport a plurality of horse-related supplies and equipment. There also exists a long-felt need in the art for a vehicle trunk tack organizer system that allows a user to easily transport a plurality of horse-related supplies and equipment in the trunk of a vehicle, wherein the system prevents the vehicle interior from becoming dirty. Further, there exists a long-felt need in the art for a vehicle trunk tack organizer system that allows a user to easily transport a plurality of horse-related supplies and equipment in the trunk of a vehicle, wherein the system prevents the vehicle interior from becoming dirtied and keeps the supplies and equipment in an organized manner.

The present invention, in one exemplary embodiment, is comprised of a vehicle trunk tack organizer system primarily comprised of at least one base with at least one recessed area, at least one saddle rack holder, and at least one cover. The base is preferably comprised of at least one side wall that is preferably taller than the base. In this manner, any liquid or debris on the top surface cannot fall off the base and dirty the surrounding area of a vehicle interior. The bottom surface of the base may also be comprised of a non-slip material. This material prevents the bottom surface from slipping within the trunk, truck bed, or interior of a vehicle.

The base may have at least one recessed area that may be specifically shaped to receive any horse equipment, food, medicine, items, objects, etc., known in the art. The recessed area secures an item in place on the base such that it does not move during transport within a vehicle. In a differing embodiment, the base may be comprised of at least one raised interior wall that forms the area.

The system is also comprised of at least one storage box. The box is preferably comprised of at least one handle and may also be comprised of at least one lid that can be locked via at least one lock of any type known in the art. The box allows a user to store horse equipment, food, medicine, items, objects, etc. The box is preferably sized such that it can fit within the recessed area. In this manner, the box cannot topple over or move on the base during transport.

At least one area (or portion of the base) may be comprised of at least one boot holder that can receive at least one boot in an upside-down manner. As a result, the holder prevents the boot from moving during transport and also prevents the bottom of a dirty boot from contacting the base. When not in use, the boot holder may be folded to the base via at least one pivot point.

Another recessed area (or portion of the base) may be comprised of at least one saddle rack holder. The holder receives at least one saddle. The holder is comprised of a cross member that receives an underside of a saddle. The saddle rack holder preferably folds toward the base when not in use.

The system is also comprised of at least one cover. The cover can be placed over the entire base during use such that the system is visually appealing. The body of the cover may be comprised of at least one fastener that attaches to at least one reciprocating fastener on the base to secure the cover to the base. The body is preferably made from a fabric material that may have at least one indicia such as, but not limited to, patterns, logos, emblems, images, symbols, designs, letters, numbers, words, characters, animals, advertisements, brands, etc., to make the cover visually appealing. The body is supported by at least one frame that may be made from a lightweight plastic material.

Accordingly, the vehicle trunk tack organizer system of the present invention is particularly advantageous as it provides a system that allows a user to easily transport a plurality of horse-related supplies and equipment in a trunk of a vehicle while preventing the vehicle interior from becoming dirty. Further, the system keeps the supplies and equipment organized while within a vehicle. In this manner, the vehicle trunk tack organizer system overcomes the limitations of existing methods of transporting horse-related supplies within a vehicle.

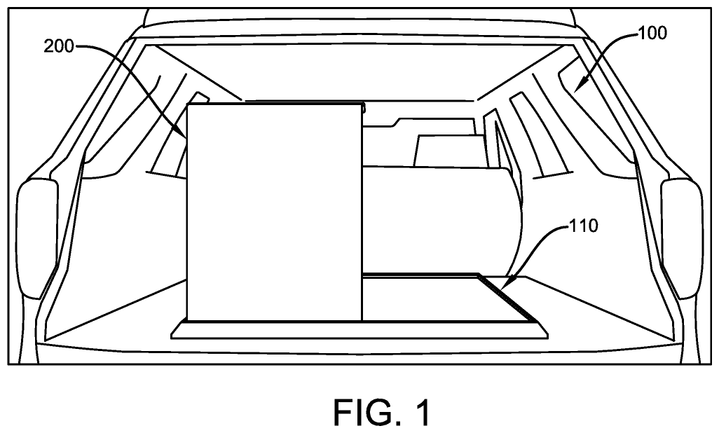

Referring initially to the drawings, FIG. 1 illustrates a perspective view of one potential embodiment of a vehicle trunk tack organizer system 100 of the present invention while inside a vehicle interior in accordance with the disclosed architecture. The system 100 is primarily comprised of at least one base 110 with at least one recessed area 120, at least one saddle rack holder, 140, and at least one cover 200. The base 110 is preferably square or rectangular in shape. However, the base 110 may be any shape known in the art such that the base 110 can fit within the interior and/or bed of a vehicle or other area. This includes, but is not limited to, triangular, circular, oval, polygonal, etc.

The base 110 may be made from a durable metal such as, but not limited to, stainless steel or aluminum. In one embodiment, the base 110 may be magnetic. The base 110 may also be made from a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In addition, the base 110 may be made from a rubber material such as, but not limited to, natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc., that is easily washable.

The base 110 is preferably comprised of at least one side wall 114. The side wall 114 is preferably taller than the base 110. In this manner, any liquid or debris on the top surface 112 cannot fall off the base 110 and dirty the surrounding area of a vehicle interior.

The bottom surface 116 of the base may be comprised of a non-slip material. The material prevents the bottom surface 116 from slipping within the trunk, truck bed, or interior of a vehicle. The bottom surface 116 material may be textured with a recessed or raised texture or may be non-textured. In the preferred embodiment, the bottom surface 116 is made from a non-slip rubber material.

The base 110 may be also comprised of at least one handle 118. The handle 118 allows the base 110 to be easily moved, adjusted, carried, etc. The handle 118 may be comprised of at least one grip area 119. The grip area 119 may be textured with a recessed or raised texture or may be non-textured. The grip area 119 is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc.

The base 110 is also comprised of at least one recessed area 120. The recessed area 120 may be any shape known in the art. The recessed area 120 may be specifically shaped to receive any horse equipment, food, medicine, items, objects, etc., known in the art. The recessed area 120 secures the item in place on the base 110 such that it does not move during transport within a vehicle. In a differing embodiment, the base 110 may be comprised of at least one raised interior wall 126 that forms the area 120, which may not be recessed (i.e., the interior wall 126 is as tall as the side wall 114).

The system 100 is also comprised of at least one storage box 130. The box 130 may be made from any material known in the art. The box 130 is preferably comprised of at least one handle 132. The handle 132 may be fixed or may be a folding handle 132. The box 130 may be comprised of at least one lid 136 that can be locked via at least one lock 134 of any type known in the art. The lid 136 may be a hinged lid 136 comprised of at least one hinge 138 of any type known in the art. The box 130 allows a user to store horse equipment, food, medicine, items, objects, etc.

More specifically, the storage box 130 is preferably sized such that it can fit within the recessed area 120. In this manner, the box 130 cannot topple over or move on the base 110 during transport. In one embodiment, the recessed area 120 and the storage box 130 are each comprised of at least one reciprocating fastener 122. The fastener 122 allows the box 130 to be secured to the area 120. The fastener 122 may be any type known in the art, such as but not limited to, hook and loop, magnet, snap button, etc. In one embodiment, the box 130 may be comprised of a metal material and wherein the base 110 is comprised of a magnetized metal material such that the box magnetically attaches to the base 110 (or vice versa).

In a different embodiment, each recessed area 120 is comprised of at least one grip area 124. The grip area 124 may be textured with a recessed or raised texture or may be non-textured. The grip area 119 is preferably made from a non-slip material that improves grip, such as but not limited to, silicone, latex, neoprene, EPDM, PVC foam, polyethylene, sponge rubber, silicone foam, urethane, cork, ridged and/or recessed rubber, felt, acrylic, polyester & SBR, etc. In this manner, the object set within the area 120 has a limited chance of moving during transport due to the friction promoted by the grip area 124.

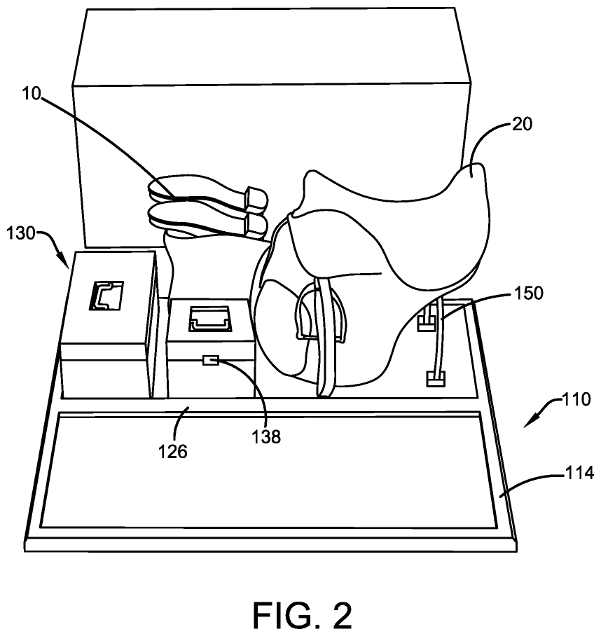

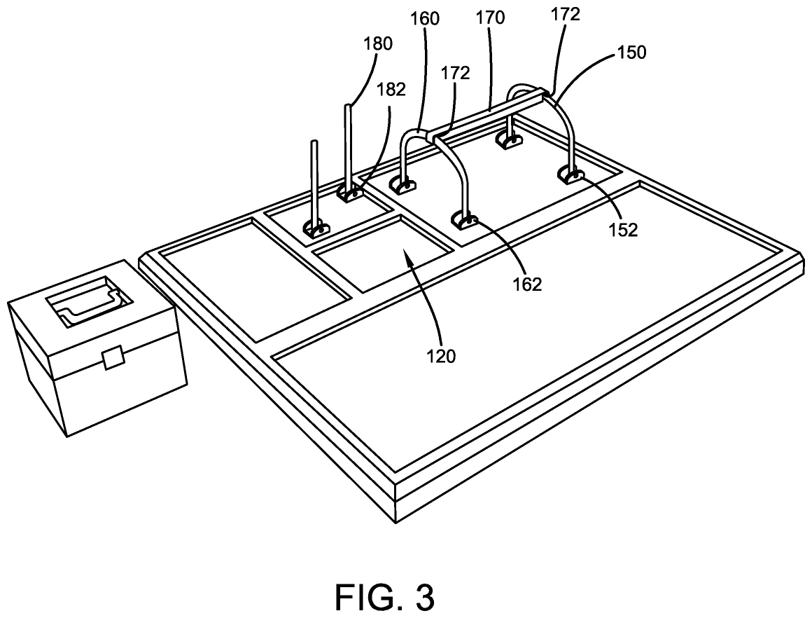

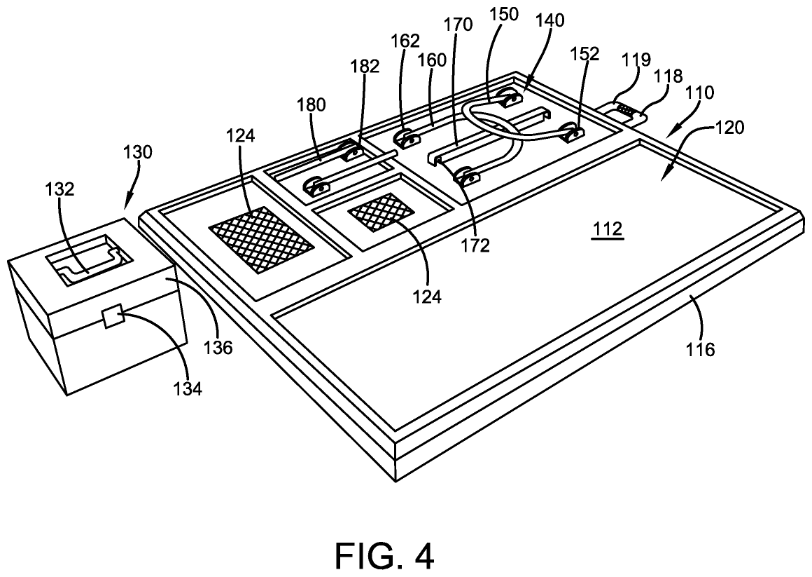

At least one area 120 (or portion of the base 110) may be comprised of at least one boot holder 180. The boot holder 180 is preferably a rectangular or cylindrical rod that can receive at least one boot 10 in an upside-down manner, as seen in FIG. 2 and FIG. 3. The holder 180 prevents the boot 10 from moving during transport and prevents the bottom of a dirty boot 10 from contacting the base 110. When not in use, the boot holder 180 may be folded to the base 110 via at least one pivot point 182, as seen in FIG. 4. The pivot point 182 may be comprised of any pivot pin or hinge type known in the art that allows the holder 180 to articulate 180 degrees relative to the top surface 112.

Another recessed area 120 (or portion of the base 110) may be comprised of at least one saddle rack holder 140. The holder 140 receives at least one saddle 20. The holder 140 is preferably comprised of a first member 150 and a second member 160 (of any shape) that attach to the base 110 via at least one pivot point 152,162. The pivot points 152,162 may be comprised of any pivot pin or hinge type known in the art that allows the members 150,160 to articulate 180 degrees relative to the top surface 112.

The members 150,160 are preferably removably or fixedly connected by at least one cross member 170. The cross member 170 may be any shape to receive the underside of a saddle 20. The cross member 170 may attach to each member 150,160 via at least one fastener 172 such as, but not limited to, a clip, a magnet, a groove, etc. The cross member 170 and first member 150 and second member 160 preferably fold toward the base 110 when not in use, as seen in FIG. 4.

The system 100 is also comprised of at least one cover 200. The cover 200 can be placed over the entire base 110 during use such that the system 100 is visually appealing. The body 210 of the cover 200 may be comprised of at least one fastener 212 that attaches to at least one reciprocating fastener 117 on the base 110. The fasteners 212,117 may be any type known in the art such as, but not limited to, hook and loop, magnet, snap-button, etc. In this manner, the cover 200 is secured to the base 110 during transport. In one embodiment, the cover 200 may slide so that it is open at the bottom and on the back side.

The body 210 is preferably made from a fabric material. The fabric material may include, but is not limited to, vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc. The body 210 may be comprised of at least one indicia 240 such as, but not limited to, patterns, logos, emblems, images, symbols, designs, letters, numbers, words, characters, animals, advertisements, brands, etc., to make the cover 200 visually appealing. The body 210 is supported by at least one frame 220 that may be made from a lightweight plastic material.

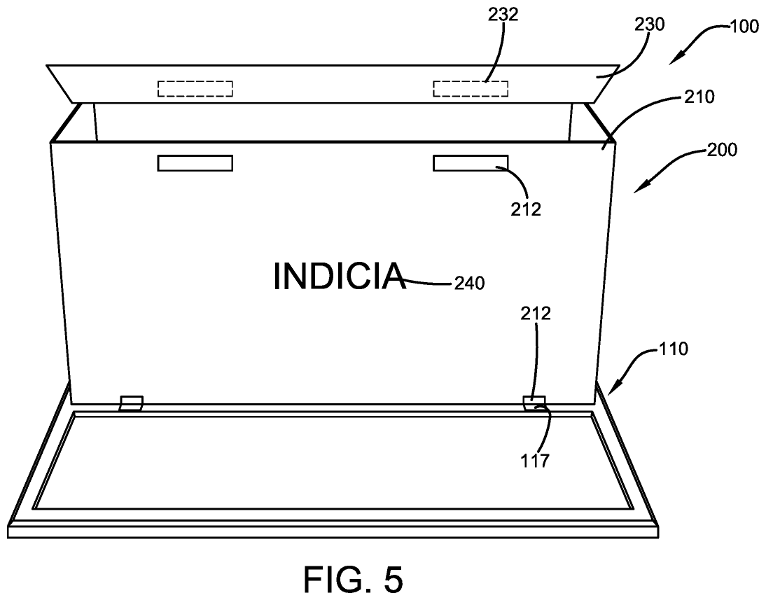

The body 210 is also comprised of at least one flap 230, as seen in FIG. 5. The flap 230 allows a user to access items within the cover 200 while the cover 200 is still secured to the base 110. The flap 230 may be comprised of at least one fastener 232 that attaches to at least one reciprocating fastener 212 on the body 210 to secure the flap 230 to the body 210. The fasteners 212,232 may be any type known in the art such as, but not limited to, hook and loop, magnet, snap-button, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle trunk tack organizer system” and “device” are interchangeable and refer to the vehicle trunk tack organizer system 100 of the present invention.

Notwithstanding the foregoing, the vehicle trunk tack organizer system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle trunk tack organizer system 100 as shown in the FIGS. are for illustrative purposes only, and that many other sizes and shapes of the vehicle trunk tack organizer system 100 are well within the scope of the present disclosure. Although the dimensions of the vehicle trunk tack organizer system 100 are important design parameters for user convenience, the vehicle trunk tack organizer system 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle trunk tack organizer system comprising:
a base;
a storage box;
a saddle rack holder positioned on the base;
a boot holder positioned on the base; and
a cover.

2. The vehicle trunk tack organizer system of claim 1, wherein each of a first fastener of the cover and a second fastener of the base is comprised of a pair of reciprocating fasteners.

3. The vehicle trunk tack organizer system of claim 1, wherein each of a third fastener of the storage box and a fourth fastener of the base is comprised of a pair of reciprocating fasteners.

4. The vehicle trunk tack organizer system of claim 1, wherein the cover is comprised of a fabric material.

5. A vehicle trunk tack organizer system comprising:
a base;
a storage box;
a saddle rack holder comprised of a first member attached to the base via a first pivot point, a second member attached to the base via a second pivot point, and a cross member that attaches to the first member and the second member;
a boot holder attached to the base via a pivot point; and
a cover comprised of a flap.

6. The vehicle trunk tack organizer system of claim 5, wherein the storage box is comprised of a lid, a hinge and a handle.

7. The vehicle trunk tack organizer system of claim 5, wherein the storage box is comprised of a metal material.

8. The vehicle trunk tack organizer system of claim 5, wherein the base is comprised of a magnetic metal.

9. The vehicle trunk tack organizer system of claim 5, wherein the base is comprised of a recessed area.

10. The vehicle trunk tack organizer system of claim 9, wherein the recessed area is comprised of a non-slip grip area.

11. The vehicle trunk tack organizer system of claim 9, wherein the storage box fits within the recessed area.

12. A vehicle trunk tack organizer system comprising:
a base comprised of a raised sidewall;
a storage box;
a saddle rack holder comprised of a first member attached to the base via a first pivot point, a second member attached to the base via a second pivot point, and a cross member that attaches to the first member and the second member;
a boot holder attached to the base via a third pivot point; and
a cover comprised of a flap and a frame.

13. The vehicle trunk tack organizer system of claim 12, wherein the base is comprised of a rubber material.

14. The vehicle trunk tack organizer system of claim 12, wherein the base is comprised of a non-slip button surface.

15. The vehicle trunk tack organizer system of claim 12, wherein the base is comprised of a handle.

16. The vehicle trunk tack organizer system of claim 12, wherein the first pivot point, the second pivot point, and the third pivot point are each comprised of a hinge.

17. The vehicle trunk tack organizer system of claim 12, wherein the base is comprised of an interior wall.

18. The vehicle trunk tack organizer system of claim 12, wherein the flap and the cover are comprised of a pair of reciprocating fasteners.

19. The vehicle trunk tack organizer system of claim 12, wherein the cross-member attaches to the first member and the second member via a fastener.

20. The vehicle trunk tack organizer system of claim 12, wherein the cover is comprised of an indicia.
